(19) United States
(12) Patent Application Publication
(10) Pub. No.: US 2008/0062053 A1
(43) Pub. Date: Mar. 13, 2008

(54) REMOTE FM MODULATION ANTENNA ARRANGEMENT

(75) Inventors: PAUL MARKO, PEMBROKE PINES, FL (US); PAUL D. KRAYESKI, WELLINGTON, FL (US); MICHAEL ABBATE, LAKE WORTH, FL (US); MICHAEL J. HARTIGAN, BOCA RATON, FL (US); ANH NGUYEN, BOYNTON BEACH, FL (US)

Correspondence Address: AKERMAN SENTERFITT, P.O. BOX 3188, WEST PALM BEACH, FL, 33402-3188, US

(73) Assignee: XM SATELLITE RADIO, INC., WASHINGTON, DC (US)

(21) Appl. No.: 11/469,330

(22) Filed: Aug. 31, 2006

(51) Int. Cl. H01Q 1/32; H04B 1/06

(52) U.S. Cl. 343/713; 455/277.1

(57) ABSTRACT

An antenna arrangement (30) for a frequency modulated modulator that intentionally modulates and transmits a source signal to a frequency modulated radio receiver (28) in a vehicle can include a portable audio source (32 or 34), a frequency modulator (10) coupled to the audio source, a coaxial transmission line (23) coupled to the frequency modulator, and a frequency modulated antenna or coupler (24) coupled to the coaxial transmission line where the coaxial transmission line is of sufficient length to enable the placement of the coupler substantially close to a frequency modulated radio receive antenna (26) coupled to the frequency modulated radio receiver in the vehicle. The portable audio source and the frequency modulator can be co-located in a single unit. The portable audio source can be a satellite radio receiver or a portable digital music player and recording device.

### CROSS-REFERENCE TO RELATED APPLICATIONS

(Not applicable)

### FIELD OF THE INVENTION

The invention relates generally to antenna arrangements, and more particularly to an antenna arrangement for use with frequency modulated (FM) modulators in a vehicle environment.

### BACKGROUND OF THE INVENTION

Intentional FM radiators must meet FCC emissions limit of 48 dBuV/m at 3 meters. One way to achieve these limits is to reduce the radiated power from the modulator. Typical wireless FM modulators either integrate the FM radiating antenna with the audio source device or utilize the device wiring as the FM radiating antenna. The problem with these approaches is that the FM modulator is normally co-located with the audio source and mounting location of the device which is within reach of the driver. This approach does not allow for optimally locating the FM radiating antenna in close proximity to the FM radio receive antenna to maximize FM capture.

Devices that currently serve as audio sources for FM modulators include MP3 players and satellite radios among other devices. Satellite radio operators are providing digital radio broadcast services covering the entire continental United States. These services offer approximately 100 channels that include music, news, sports, talk and data channels. Digital radio may also be available in the near future from conventional analog radio broadcasters that will provide a terrestrial based system using signals co-located in the AM and FM bands. Satellite radios typically use a quadrifilar type antenna that needs to have direct exposure to a signal transmitted from a satellite.

### SUMMARY OF THE INVENTION

Thus, embodiments in accordance with the invention attempt to achieve a lower path loss between the intentional FM radiation source and the vehicle FM radio receive antenna to maximize the opportunity for signal capture at the FM receiver. In other words, embodiments attempt to reduce the free space path loss from an intentional FM modulated source to a vehicle FM receive antenna. Such embodiments can include simplified end user installation schemes.

In a first aspect of the present invention, an antenna arrangement for a frequency modulated modulator that intentionally modulates and transmits a source signal to a frequency modulated radio receiver in a vehicle can include a frequency modulator coupled to a portable audio source (such as a satellite radio, portable MP3 player, combined cellular phone and MP3 player and the like), a coaxial transmission line coupled to the frequency modulator, and a frequency modulated antenna coupled to the coaxial transmission line where the coaxial transmission line is of sufficient length to enable the placement of the frequency modulated antenna substantially close to a frequency modulated radio receive antenna coupled to the frequency modulated radio receiver in the vehicle. The portable audio source and the frequency modulator can be co-located in a single unit. The antenna arrangement can further include a control unit coupled to the portable audio source that can also be co-located with the portable audio source and the frequency modulator in a single unit. The portable audio source can be a satellite radio receiver or a portable digital music player and recording device. The coaxial transmission line can be a satellite digital radio receiver antenna and the frequency modulated antenna can be a loop antenna that radiates the source signal. The coaxial transmission line can be at least a first portion that splits and forms a satellite digital radio receiver antenna and a second portion that splits and forms a frequency modulated antenna coupler that radiates the source signal to and couples to the frequency modulated radio receive antenna with substantially no air gap between the antenna coupler and the frequency modulated radio receive antenna. As noted above, the antenna arrangement can be user installable within the vehicle. The antenna arrangement can include a ferrite choke on the coaxial transmission line. The frequency modulated antenna can be placed on a front or rear windshield near a radio frequency modulated receive antenna embedded within the front or rear windshield. Alternatively, the frequency modulated antenna can be placed on a front or rear windshield of the vehicle near an external radio frequency modulated received antenna. The antenna arrangement can further include a cigarette lighter adaptor that provides power to the frequency modulator and the portable audio source and further provides audio signals from the audio source to the frequency modulator. Also note, the antenna system can include the frequency modulated radio receive antenna itself to the extent that the frequency modulated radio receive antenna is included in test evaluations of emission limits.

In a second aspect of the present invention, an antenna arrangement for a frequency modulated modulator that intentionally modulates and transmits a source signal to a frequency modulated radio receiver in a vehicle can include a satellite radio receiver, a frequency modulator coupled to the satellite radio receiver, a cigarette lighter adaptor that provides power to the frequency modulator and the satellite radio receiver and provides audio signals from the satellite radio receiver to the frequency modulator, a coaxial transmission line coupled to the frequency modulator, and a frequency modulated antenna coupled to the coaxial transmission line where the coaxial transmission line is of sufficient length to enable the placement of the frequency modulated antenna substantially close to a frequency modulated radio receive antenna coupled to the frequency modulated radio receiver in the vehicle. The coaxial transmission line can be a satellite digital radio receiver antenna and the frequency modulated antenna can be in the form of a loop antenna that radiates the source signal. The coaxial transmission line can be at least a first portion that splits and forms a satellite digital radio receiver antenna and a second portion that splits and forms the frequency modulated antenna that radiates the source signal. The cigarette lighter adapter can provide audio signals from the satellite digital radio receiver antenna to the satellite radio receiver. As noted above, the antenna arrangement can be user installable within the vehicle. The frequency modulated antenna can be placed on a front or rear windshield near a radio frequency modulated receive antenna embedded within the front or rear windshield or the frequency modulated antenna can be placed on a front or rear windshield of the vehicle near an external radio frequency modulated received antenna.

In a third aspect of the present invention, a method of frequency modulating an audio source in a vehicle environment toward a frequency modulated receive antenna forming a part of the vehicle environment can include the steps of intentionally frequency modulating the audio source forming a modulated signal at a frequency modulator, radiating the modulated signal from a frequency modulated transmit antenna at a location remote from the frequency modulator, and placing the frequency modulated transmit antenna in substantially close proximity to the frequency modulated receive antenna. The method can further include the step of receiving a satellite radio signal that provides the audio source at a satellite radio antenna coupled to the frequency modulated transmit antenna. The method can also include placing the frequency modulated transmit antenna in substantially close proximity by placing the frequency modulated transmit antenna using a coupler such that substantially no air gap exists between the coupler and the frequency modulated receive antenna. The method can further intentionally radiate the modulated signal through the frequency modulated receive antenna. In this regard, the method can include evaluating an emission limit of a radiated power of the modulated signal from the frequency modulator by measuring the radiated power that radiates from the frequency modulated receive antenna.

### BRIEF DESCRIPTION OF THE DRAWINGS

FIG. 1 illustrates a block diagram of a frequency modulated modulator in accordance with an embodiment of the present invention.

FIG. 2 illustrates an antenna arrangement where an FM modulated radiator coupler couples to an external FM receive antenna in accordance with an embodiment of the present invention.

FIG. 3 illustrates another antenna arrangement where the FM modulated radiator coupler couples to an embedded glass FM receive antenna in accordance with an embodiment of the present invention.

FIG. 4 illustrates another antenna arrangement using a docking station in accordance with an embodiment of the present invention.

FIG. 5 illustrates another antenna arrangement where an FM modulated radiator coupler couples to an external FM receive antenna in accordance with an embodiment of the present invention.

FIG. 6 is a block diagram of an antenna arrangement using a cigarette lighter adaptor in accordance with an embodiment of the present invention.

FIG. 7A is an existing wireless FM modulator system and test scheme.

FIG. 7B is an illustration of an FM modulator system and test scheme in accordance with an embodiment of the present invention.

FIG. 8 is another antenna arrangement in accordance with an embodiment of the present invention.

FIG. 9 is an external antenna using a coupling clip in accordance with an embodiment of the present invention.

FIG. 10 is a glass mounted antenna using coupling clip and contact bracket in accordance with another embodiment of the present invention.

FIG. 11 is the antenna arrangement of FIGS. 8 and 9 on a car as applied to an external FM receive antenna.

FIG. 12 is an exploded view of the glass mounted antenna of FIG. 10 in accordance with an embodiment of the present invention.

FIG. 13 is the antenna arrangement of FIGS. 8 and 10 or 12 on a car as applied to an FM receive antenna embedded in a front window in accordance with an embodiment of the present invention.

FIG. 14 is a flow chart illustrating a method of frequency modulating an audio source in a vehicle environment toward a frequency modulated receive antenna in accordance with an embodiment of the present invention.

### DETAILED DESCRIPTION OF THE DRAWINGS

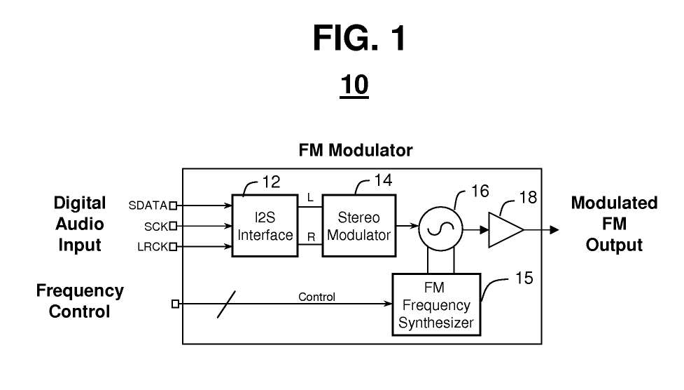

Referring to FIG. 1, a block diagram of an FM frequency modulator 10 as can be used with embodiments of the present invention is shown. The modulator 10 can include a digital audio input and interface 12 that can receive digital audio from an audio source such as an MP3 player or a satellite radio. The interface 12 can provide left and right inputs to a stereo modulator 14 which provides an output to an oscillator 16 that can be controlled by a frequency controlled FM frequency synthesizer 15. The output of the oscillator 16 can be amplified by amplifier 18 to provide an FM modulated output of the source signal or digital audio input.

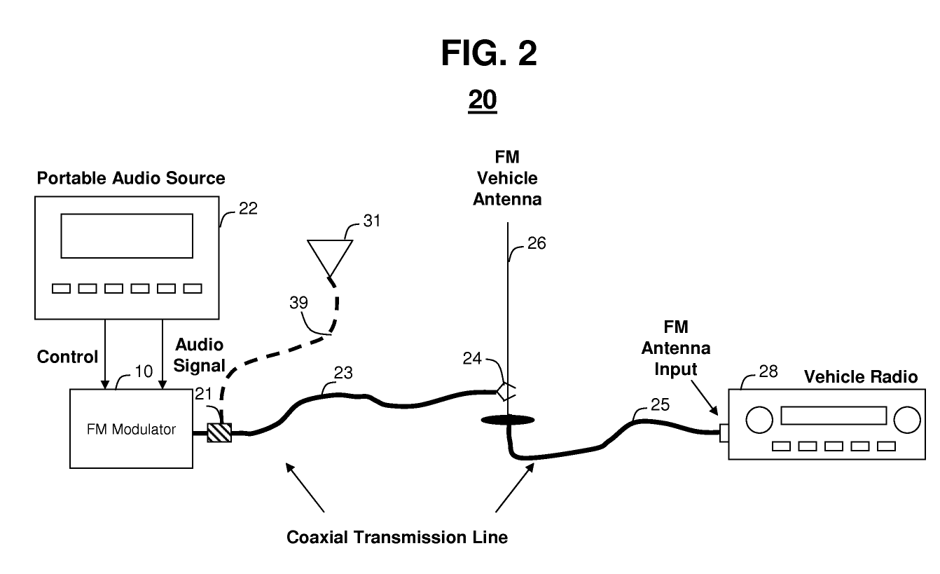

Referring to FIG. 2, the frequency modulator 10 is shown coupled to a portable audio source 22 in an antenna arrangement 20. The portable audio source can be a satellite radio having a user interface that can provide an audio signal as well as control signals for controlling the frequency of the modulator 10. The antenna arrangement 20 can further include a coaxial transmission line 23 coupling the FM modulator 10 to a remote FM transmit or radiating antenna or coupler 24. The antenna or coupler 24 can include a meandering line antenna suitable for transmitting in the FM range, but can alternatively include a clamp or coupling mechanism for physical coupling to an FM vehicle receive antenna 26 as shown. As discussed above, previous antenna arrangements used just the coaxial transmission line as the radiating element that generally radiated from all portions of the coaxial transmission line. Instead, the embodiment herein can reduce splattering transmissions from the coaxial transmission line 23 by utilizing a ferrite core or choke to enable the desired coupling and enable focused radiation by the antenna or coupler 24. The FM transmit antenna or coupler 24 can be strategically placed substantially near the FM vehicle receive antenna 26 in order to achieve a lower path loss between the intentional FM radiation source and the vehicle FM radio antenna and to maximize the opportunity for signal capture at the FM receiver 28. “Substantially near” in most embodiments using a coupler can mean a distance of approximately less than one (1) millimeter away and can generally be interpreted as substantially no air gap between the FM transmit coupler and the FM receive antenna. As shown, the FM receive antenna 26 can be coupled to the FM receiver 28 via another coaxial transmission line 25. Optionally, in the context of a satellite radio, the antenna arrangement can further include another coaxial transmission line 39 coupled to a satellite receive antenna 31 via a module 21 having a diplexor as will be further discussed. In this regard, the module 21 can include additional circuitry that amplifies the FM modulated signal (e.g., a linear amplifier) for transmission to the FM receive antenna 26 and that further amplifies the received satellite signal received at antenna 31 and send back via transmission line 39 towards the device 22 (when the device 22 is a satellite radio receiver).

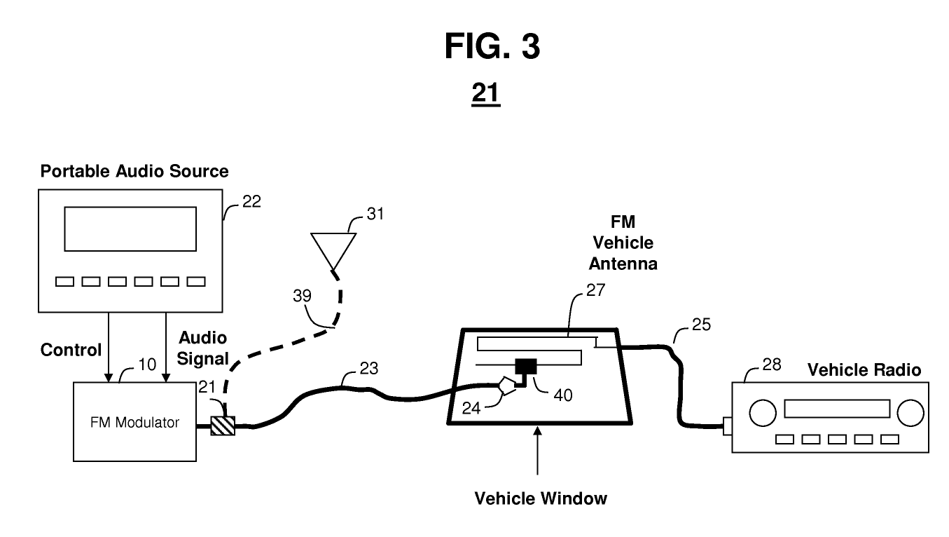

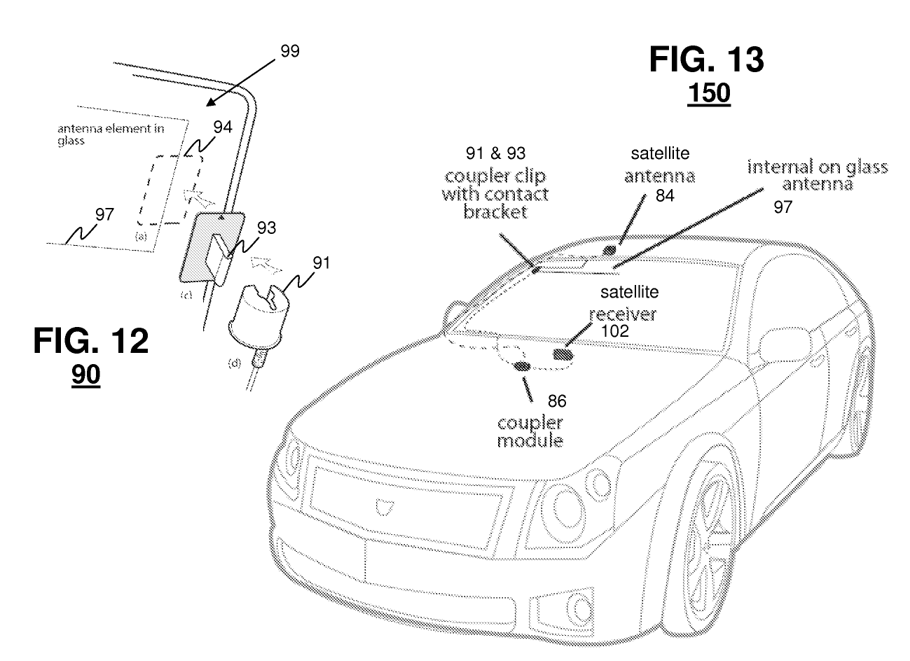

Referring to FIG. 3, a similar antenna arrangement 21 includes all the same elements as found in the arrangement 20 of FIG. 2, except that the FM transmit antenna or coupler 24 couples to an FM receive antenna 27 that is embedded in a vehicle window. In this instance, the coupler 24 can attach or couple substantially near the antenna 27 using a bracket 40 similar to the arrangement shown in FIG. 12.

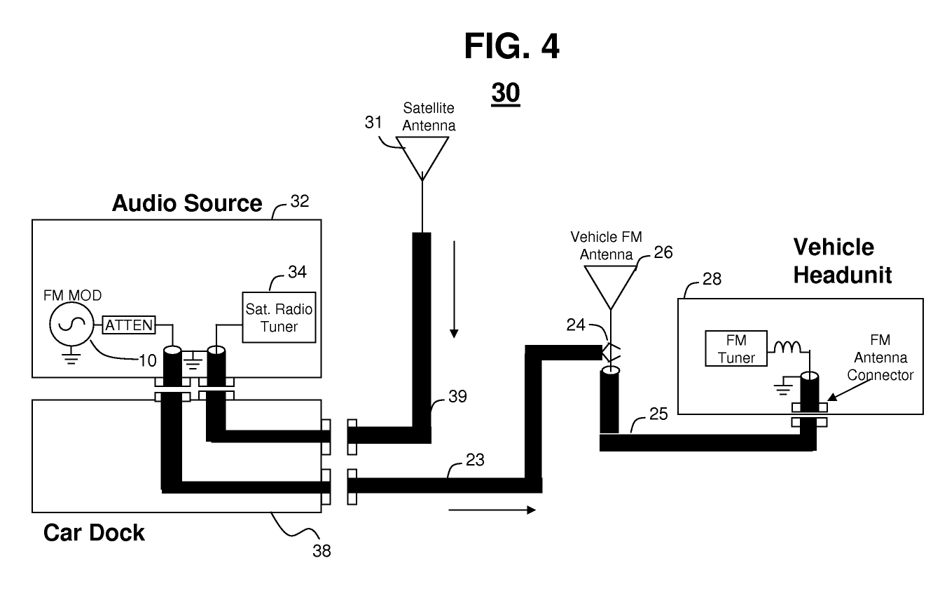

Referring to FIG. 4, another similar antenna arrangement 30 to antenna arrangement 20 includes an audio source 32 having integrated therein the FM modulator 10 and a satellite receiver or tuner 34 serving as the source signal. The audio source 32 can receive a source signal and radiate a modulated source signal via a car docking station 38 as shown. To reduce the chances of splatter by the coaxial line 23, the modulator 10 can be coupled to an attenuator. Optionally, the attenuator can be made to significantly attenuate the FM modulated signal from antenna 31 when the audio source 32 is coupled to a car docking station 38 and when the car docking station 38 is coupled to the coaxial transmission line 23. The coaxial transmission line 39 can couple to the satellite receive antenna 31 and coaxial transmission line 23 can couple to the FM transmit antenna or coupler 24 that can be strategically placed in close proximity to the vehicle FM receive antenna 26. The vehicle FM receive antenna 26 is coupled to the vehicle headunit 28 via transmission line 25. The vehicle headunit can include an FM radio station tuner and complementary controls for changing such stations, altering the volume, equalizing, and performing other common functions found in car stereos.

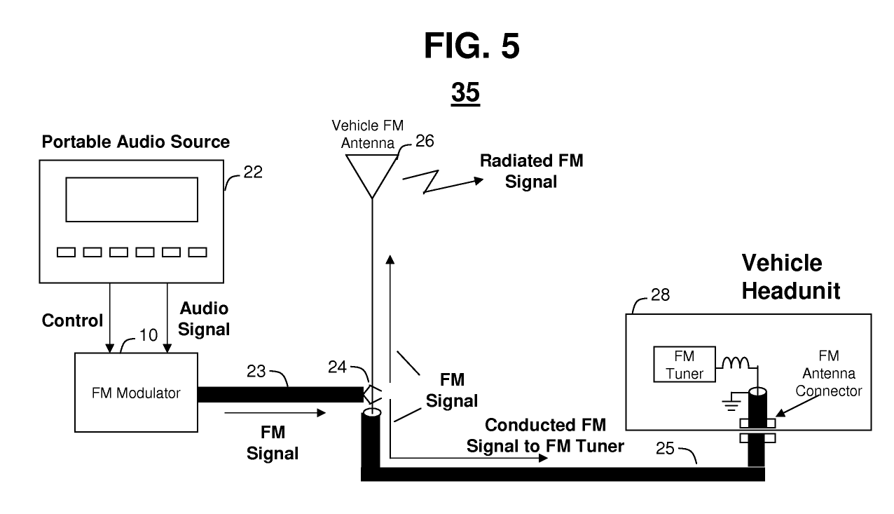

Referring to FIG. 5, another similar antenna arrangement 35 is shown that does not necessarily include a satellite receive antenna. In this arrangement, similar to antenna arrangement 20 the frequency modulator 10 is shown coupled to a portable audio source 22. The portable audio source can be a satellite radio having a user interface that can provide an audio signal as well as control signals for controlling the frequency of the modulator 10. The antenna arrangement 35 can further include a coaxial transmission line 23 coupling the FM modulator 10 to a remote FM transmit or radiating antenna or coupler 24. The FM transmit antenna or coupler 24 can be strategically placed substantially near the FM vehicle receive antenna 26 in order to achieve a lower path loss between the intentional FM radiation source and the vehicle FM radio antenna and to maximize the opportunity for signal capture at the FM receiver 28. As shown, the FM receive antenna 26 can be coupled to the FM receiver 28 via another coaxial transmission line 25. Note, although the FM modulated signal is conducted to the FM tuner of the FM receiver or vehicle head unit 28 via coaxial transmission line 25, the FM modulated signal is also radiated via the vehicle FM receive antenna 26. As will be discussed further below, emission limit tests will include the measure of radiated power from the vehicle FM receive antenna 26.

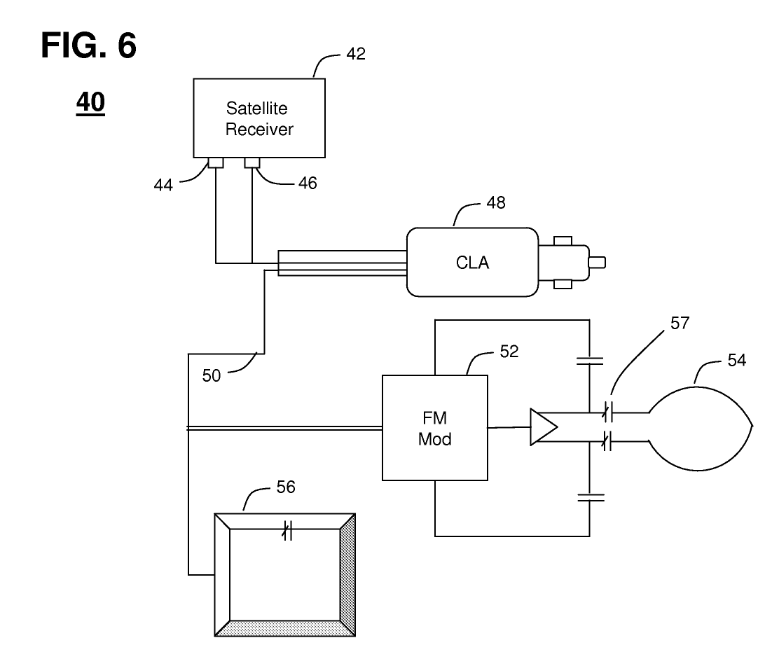

Referring to FIG. 6, yet another antenna arrangement 40 is shown. In this embodiment, an audio source in the form of a satellite receiver 42 includes a power port 44 and audio port 46 that couples via a multi-wire connection to a satellite receive antenna 56 and an FM loop antenna 54 and modulator 54 via a cigarette lighter adaptor (CLA) 48. The CLA 48 can power the satellite receiver 42 via power port 44 and can serve to provide received signals from the satellite receive antenna 56 back to the satellite receiver 42 via audio port 46. Furthermore, the audio port 46 and CLA 48 can further provide audio signals to the FM modulator 52 for transmission via the FM loop antenna 54. Note, in this instance, that a transmission line 50 between the CLA 48 and the antennas 56 and 54 split off forming the satellite receive antenna 56 in one direction and the FM modulator 52 and FM loop antenna 54 in another direction. With this embodiment, the FM modulator 52 and FM loop antenna 54 can be strategically place next to a vehicle FM receive antenna (not shown). The antenna arrangement 40 can further include tunable capacitors or varactors 57 that can help tune the modulated signal from the FM modulator 52 to a desired frequency for reception by the vehicle FM receiver.

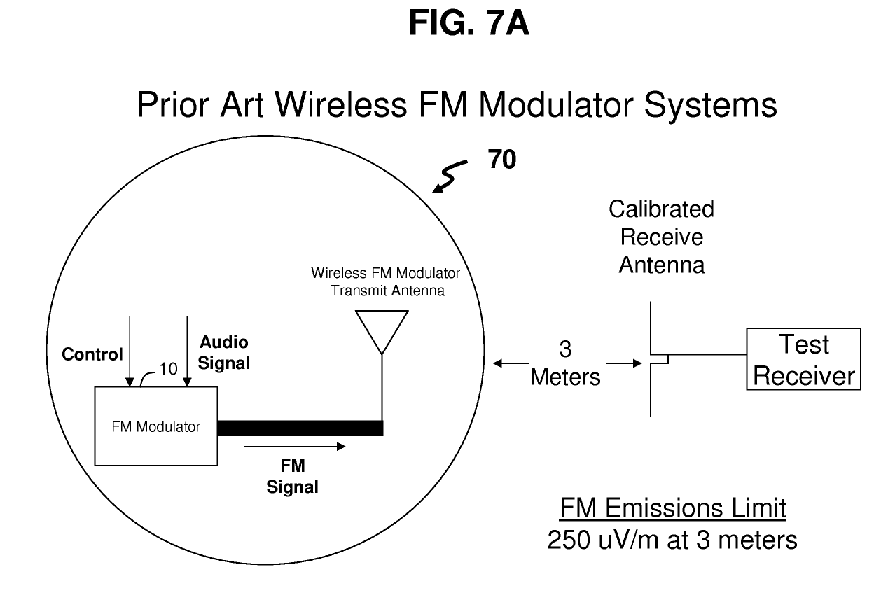

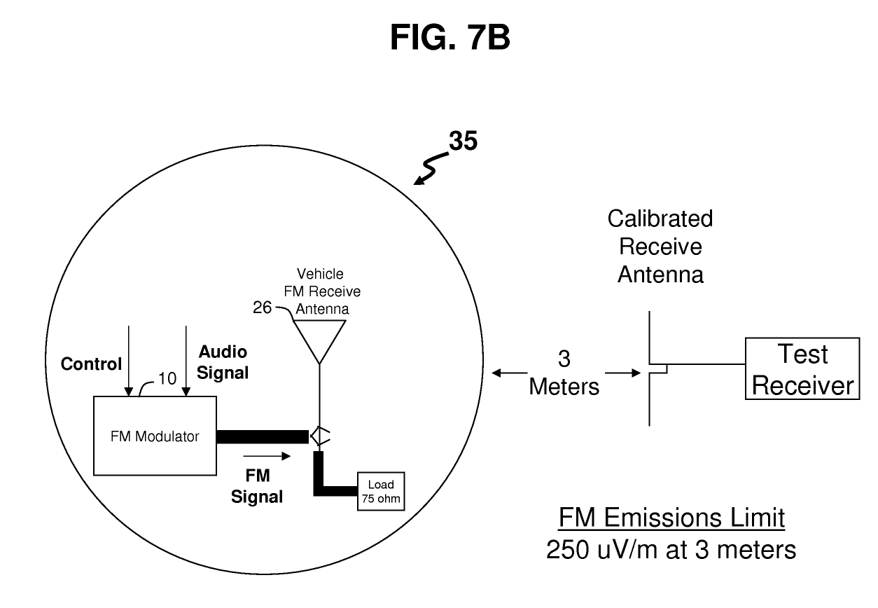

Referring to FIGS. 7A and 7B, FM modulator emission limit tests systems are shown. In FIG. 7A, an existing system test measures for an FM emissions limit of 250 uV/m at 3 meters from an existing intentional FM modulator system 70. The test typically includes the measurement radiated from the modulator 10 and FM transmit antenna at a calibrated receive test antenna and test receiver that is 3 meters away from the modulator system 70. In contrast, in FIG. 7B, in accordance with the embodiments herein, the FM emissions test makes measurements from a FM modulator system 35 that includes a vehicle FM receive antenna 26 that is coupled to the FM modulator 10.

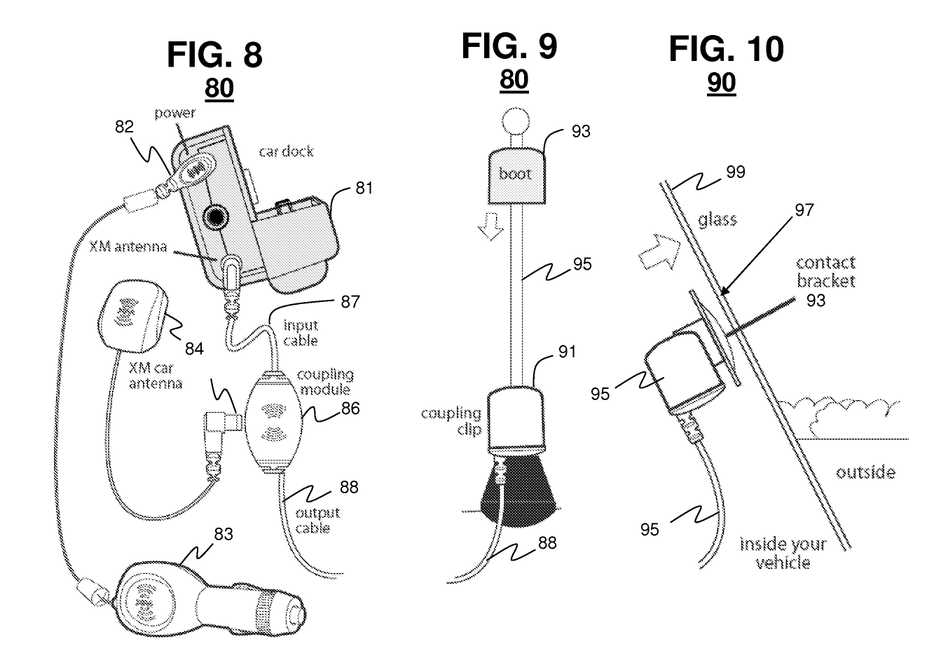

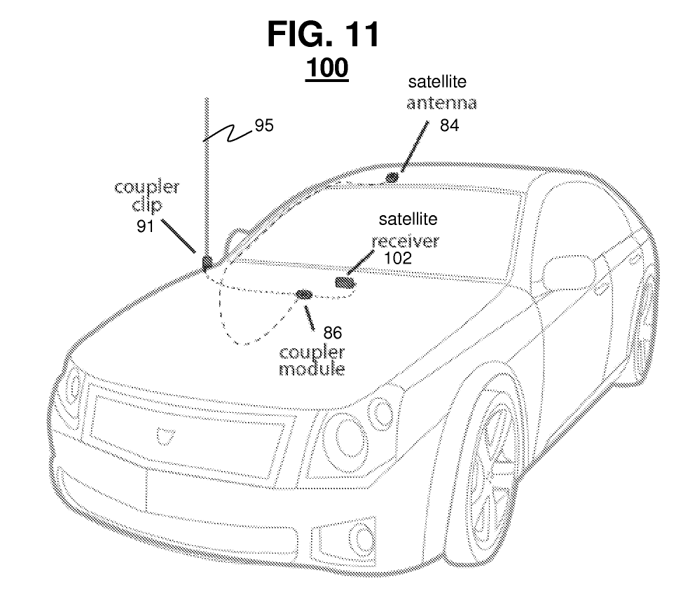

Referring to FIGS. 8 through 13 other various configurations of an antenna arrangement in accordance with the present invention are shown. A satellite radio 102 as shown in FIG. 11 or 12 can be coupled to a docking station 81 in an antenna arrangement 80 as shown in FIG. 8. The docking station 81 can receive power at a power input port 82 from a cigarette lighter adaptor 83 (coupled to the car battery (not shown)). A satellite antenna 84 can be coupled to an FM coupler module 86 using connector 85. The coupler module 86 can also include an input cable 87 for coupling to the docking station 81 as well as an output cable 88 that leads to a coupling clip 91 as illustrated in the arrangements 89 or 90 of FIG. 9 or 10 respectively. The embodiment of FIG. 9 is for attachment of the coupling clip 91 to or around an external antenna 95 while the embodiment of FIG. 10 is for attachment of the coupling clip 91 to or on an internal on-glass antenna 97. The arrangement 89 of FIG. 9 can further include a boot that can be placed over the coupling clip 91 once the clip is mounted on the antenna 95. The arrangement 90 can include a contact bracket 93 that can have an adhesive backing for attachment to an glass 99 on an inside portion of a vehicle. The contact bracket 93 can mate with the coupling clip 91 and then can adhere to an area 94 on the glass 99 that includes the embedded FM receive antenna 97 as seen in FIG. 10 and as more clearly illustrated in FIG. 12. FIGS. 11 and 13 merely show how the respective antenna arrangements 89 or 90 can be mounted on a car that either has an external FM antenna as in system 100 of FIG. 11 or an embedded FM glass mounted antenna as in system 150 of FIG. 13.

The FM coupler 86 can be designed to deliver the FM modulated signal from the satellite radio receiver 102 to the vehicle FM radio by capacitive or inductively coupling the FM signal directly to the vehicle FM receive antenna (95 or 97). Other embodiments can alternatively directly couple the FM receive antenna. The FM modulated signal is output from the satellite radio receiver 102 on a connector such as an RF subminiature B or SMB connector which also carries the S-Band satellite radio signals received from the satellite antenna 84. The coupler system or FM coupler 86 contains a short section of RF coaxial cable 87 which is connected to the satellite receiver SMB connector at one end and to a diplexor box at the other end. The diplexor box interface also include a connector 85 such as an SMB connector for connecting the satellite antenna 84 and a longer section of coax which is terminated with a spring or coupling clip 91 for attachment to the vehicle FM antenna as discussed above. A discrete filter circuit in the diplexor box within the coupler 86 provides a low loss path for the S-Band satellite radio signals to travel from the satellite antenna 84 to the satellite receiver 102 while attenuating the satellite signals to the long section 88 of coaxial cable to the FM antenna (95 or 97). Similarly, the diplexor box can provide a low loss path for the FM signals from the satellite receiver to travel to the FM antenna along the long section 88 of coaxial cable while attenuating the FM signal to the satellite antenna 84. The spring or coupling clip 91 at the end of the long section 88 of coaxial cable can be connected directly to the coaxial center conductor which contains the FM signal. When the spring or coupling clip 91 is either clipped onto an aerial antenna (95) or clipped onto the window antenna attachment, maximum FM energy can be transferred to the FM radio through the capacitive coupling at the antenna. In order to reduce the FM signal radiating from the shield of the long coaxial section, two small ferrites can be molded onto the coaxial cable approximately up to 1 foot from the spring or coupling clip 91.

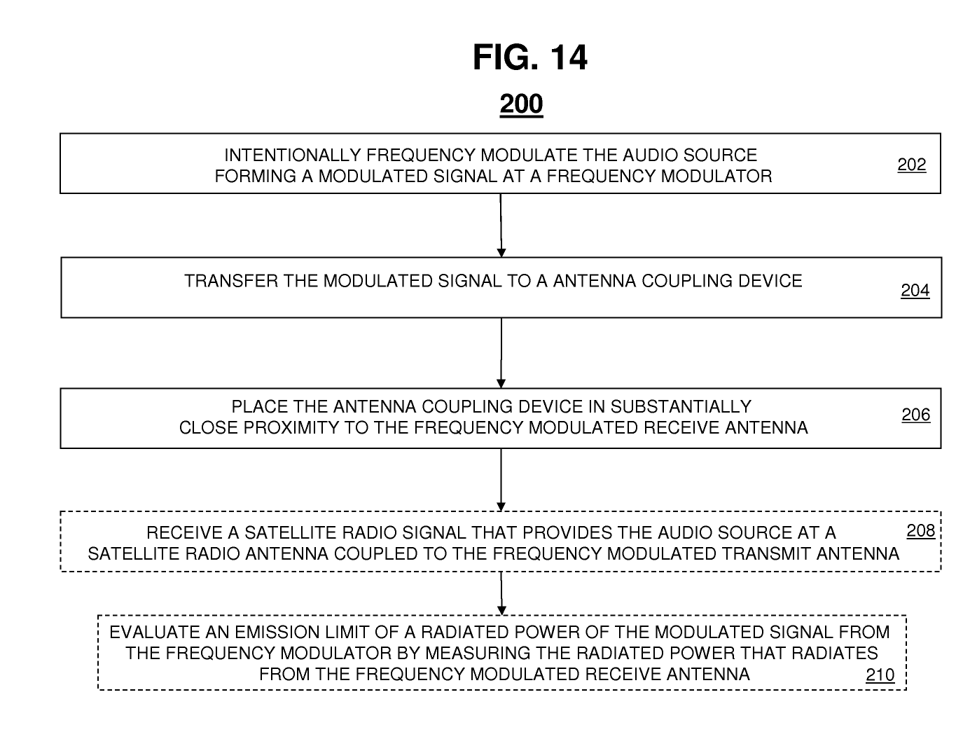

Referring to FIG. 14, a method 200 of frequency modulating an audio source in a vehicle environment toward a frequency modulated receive antenna forming a part of the vehicle environment can include the step 202 of intentionally frequency modulating the audio source forming a modulated signal at a frequency modulator, radiating the modulated signal from a frequency modulated transmit antenna at a location remote from the frequency modulator at step 204, and placing the frequency modulated transmit antenna in substantially close proximity to the frequency modulated receive antenna at step 206. The method 200 can further include the step 208 of receiving a satellite radio signal that provides the audio source at a satellite radio antenna coupled to the frequency modulated transmit antenna. The method 200 can also include the step 210 of evaluating an emission limit of a radiated power of the modulated signal from the frequency modulator by measuring the radiated power that radiates from the frequency modulated receive antenna.

It should be realized that embodiments in accordance with the present invention can be realized in hardware, software, or a combination of hardware and software. In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

We claim:

1. An antenna arrangement for a frequency modulated modulator that intentionally modulates and transmits a source signal to a frequency modulated radio receiver in a vehicle, comprising:
a frequency modulator coupled to a portable audio source;
a coaxial transmission line coupled to the frequency modulator; and
a frequency modulated antenna coupled to the coaxial transmission line, wherein the coaxial transmission line is of sufficient length to enable the placement of the frequency modulated antenna substantially close to a frequency modulated radio receive antenna coupled to the frequency modulated radio receiver in the vehicle.

2. The antenna arrangement of claim 1, wherein the portable audio source and the frequency modulator are co-located in a single unit.

3. The antenna arrangement of claim 1, wherein the antenna arrangement further comprises a control unit coupled to the portable audio source.

4. The antenna arrangement of claim 3, wherein the portable audio source, the frequency modulator, and the control unit are co-located in a single unit.

5. The antenna arrangement of claim 1, wherein the portable audio source is a satellite radio receiver or a portable digital music player and recording device.

6. The antenna arrangement of claim 1, wherein the coaxial transmission line comprises a satellite digital radio receiver antenna and the frequency modulated antenna is in the form of a loop antenna that radiates the source signal.

7. The antenna arrangement of claim 1, wherein the coaxial transmission line comprises at least a first portion that splits and forms a satellite digital radio receiver antenna and a second portion that splits and forms the frequency modulated antenna coupler that radiates the source signal to and couples to the frequency modulated radio receive antenna with substantially no air gap between the antenna coupler and the frequency modulated radio receive antenna.

8. The antenna arrangement of claim 1, wherein the antenna arrangement further comprises a ferrite choke on the coaxial transmission line.

9. The antenna arrangement of claim 1, wherein the frequency modulated antenna is placed on a front or rear windshield near a radio frequency modulated receive antenna embedded within the front or rear windshield.

10. The antenna arrangement of claim 1, wherein the frequency modulated antenna is placed on a front or rear windshield of the vehicle near an external radio frequency modulated received antenna.

11. The antenna arrangement of claim 1, wherein the antenna arrangement further comprises the frequency modulated radio receive antenna to the extent the frequency modulated radio receive antenna is included in test evaluations of emission limits.

12. An antenna arrangement for a frequency modulated modulator that intentionally modulates and transmits a source signal to a frequency modulated radio receiver in a vehicle, comprising:
a satellite radio receiver;
a frequency modulator coupled to the satellite radio receiver;
a cigarette lighter adaptor that provides power to the frequency modulator and the satellite radio receiver and provides audio signals from the satellite radio receiver to the frequency modulator;
a coaxial transmission line coupled to the frequency modulator; and
a frequency modulated antenna coupled to the coaxial transmission line, wherein the coaxial transmission line is of sufficient length to enable the placement of the frequency modulated antenna substantially close to a frequency modulated radio receive antenna coupled to the frequency modulated radio receiver in the vehicle.

13. The antenna arrangement of claim 12, wherein the coaxial transmission line comprises a satellite digital radio receiver antenna and the frequency modulated antenna is in the form of a loop antenna that radiates the source signal.

14. The antenna arrangement of claim 13, wherein the cigarette lighter adapter further provides audio signals from the satellite digital radio receiver antenna to the satellite radio receiver.

15. The antenna arrangement of claim 12, wherein the coaxial transmission line comprises at least a first portion that splits and forms a satellite digital radio receiver antenna and a second portion that splits and forms the frequency modulated antenna that radiates the source signal.

16. A method of frequency modulating an audio source in a vehicle environment toward a frequency modulated receive antenna forming a part of the vehicle environment, comprising the steps of:
intentionally frequency modulating the audio source forming a modulated signal at a frequency modulator;
radiating the modulated signal from a frequency modulated transmit antenna at a location remote from the frequency modulator; and
placing the frequency modulated transmit antenna in substantially close proximity to the frequency modulated receive antenna.

17. The method of claim 16, wherein the method further comprises receiving a satellite radio signal that provides the audio source at a satellite radio antenna coupled to the frequency modulated transmit antenna.

18. The method of claim 16, wherein the step of placing the frequency modulated transmit antenna in substantially close proximity comprises the step of placing the frequency modulated transmit antenna using a coupler such that substantially no air gap exists between the coupler and the frequency modulated receive antenna.

19. The method of claim 16, wherein the method further comprises the step of intentionally radiating the modulated signal through the frequency modulated receive antenna.

20. The method of claim 16, wherein the method further comprises the step of evaluating an emission limit of a radiated power of the modulated signal from the frequency modulator by measuring the radiated power that radiates from the frequency modulated receive antenna.
